(19) United States
(12) Patent Application Publication
(10) Pub. No.: US 2009/0058271 A1
(43) Pub. Date: Mar. 5, 2009

(54) Organic light emitting device

(75) Inventors: Hongmo Koo, Gumi-city (KR); Gyungrae Kim, Gumi-city (KR)

Correspondence Address: KED & ASSOCIATES, LLP, P.O. Box 221200, Chantilly, VA, 20153-1200, US

(73) Assignee: LG Electronics Inc.

(21) Appl. No.: 11/987,752

(22) Filed: Dec. 4, 2007

(30) Foreign Application Priority Data
Aug. 28, 2007 (KR) 10-2007-0086458
Aug. 28, 2007 (KR) 10-2007-0086461

(51) Int. Cl. H01J 1/63

(52) U.S. Cl. 313/504

(57) ABSTRACT

An organic light emitting device is provided that includes a substrate having a plurality of subpixels provided thereon, an insulating film provided on the substrate and configured to divide a plurality of subpixels, and a plurality of spacers provided on the insulating film each having a positive taper shape. A height of each spacer may be approximately 2.6 to 4.0 greater than a height of the insulating film.

### ORGANIC LIGHT EMITTING DEVICE

This application claims priority from Korean Patent Application Nos. 10-2007-0086458 and 10-2007-0086461, both filed Aug. 28, 2007, the subject matters of which are incorporated herein by reference.

### BACKGROUND

1. Field

Embodiments of the present invention may relate to a display device. More specifically, embodiments of the present invention may relate to an organic light emitting device.

2. Background

The importance of a flat panel displays (FPD) has increased with development of multimedia. Various kinds of displays such as a liquid crystal display (LCD) device, a plasma display panel (PDP), a field emission display (FED) and an organic light emitting device have been commercialized.

An organic light emitting device may have a high response speed (of 1 ms or less), a low power consumption and may be of a self-light emitting type. The organic light emitting device may be considered a next-generation display device since the organic light emitting device may lack viewing angle problems.

An organic light emitting device may be a self-light emitting device in which a light emitting layer is formed between two electrodes disposed on a substrate.

The organic light emitting device may be a passive matrix type or an active matrix type depending on a driving technique.

An organic light emitting device may be fabricated through a manufacturing process that includes patterning an anode, an insulating film process, deposition of an organic material and a cathode on a substrate, and performing passivation, an encapsulation process, etc.

A spacer may be formed on the substrate in this manufacturing process. The spacer may support a metal mask and an encapsulation member, for example. The spacer may also prevent stress by open air or an external pressure.

In the manufacturing process, a mask may attempt to prevent shock, scratch and/or the like to an organic light emitting layer within a subpixel and in order to avoid increasing a failure rate or lowering uniformity of a thin film.

### BRIEF DESCRIPTION OF THE DRAWINGS

Arrangements and embodiments of the present invention may be described in detail with reference to the following drawings in which like reference numerals refer to like elements and wherein:

FIGS. 1A to 1C illustrate various arrangements of a color image display method in an organic light emitting device;

FIG. 2 is a view illustrating an organic light emitting device in accordance with an example embodiment of the present invention;

FIG. 3 is a cross-sectional view of a subpixel of an organic light emitting device in accordance with an example embodiment of the present invention;

FIG. 4 is a cross-sectional view of a spacer and an insulating film of an organic light emitting device in accordance with an example embodiment of the present invention;

FIG. 5 is a cross-sectional view of a spacer and an insulating film of an organic light emitting device in accordance with an example embodiment of the present invention;

FIG. 6 is a view illustrating width of an insulating film and width of a spacer of an organic light emitting device in accordance with an example embodiment of the present invention; and

FIGS. 7 to 9 are schematic plan views of an organic light emitting device in accordance with example embodiments of the present invention.

### DETAILED DESCRIPTION

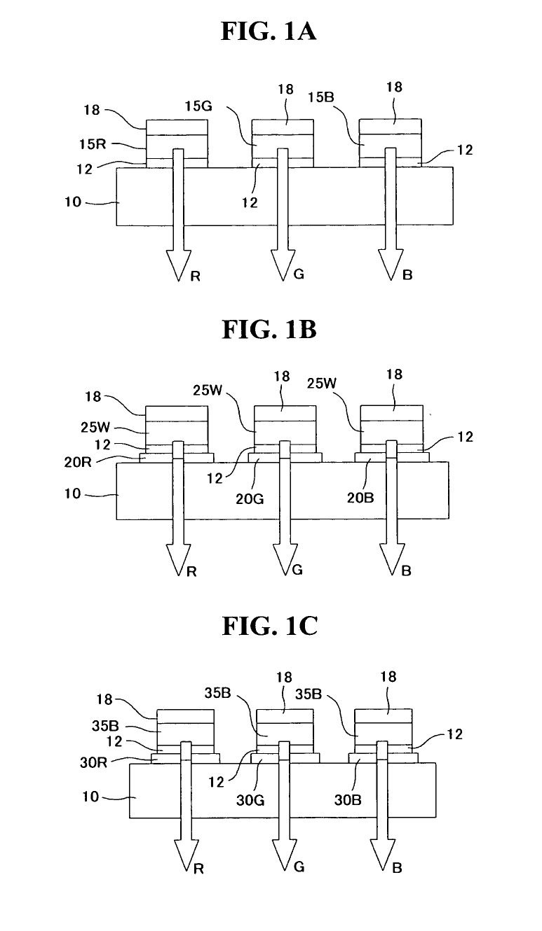

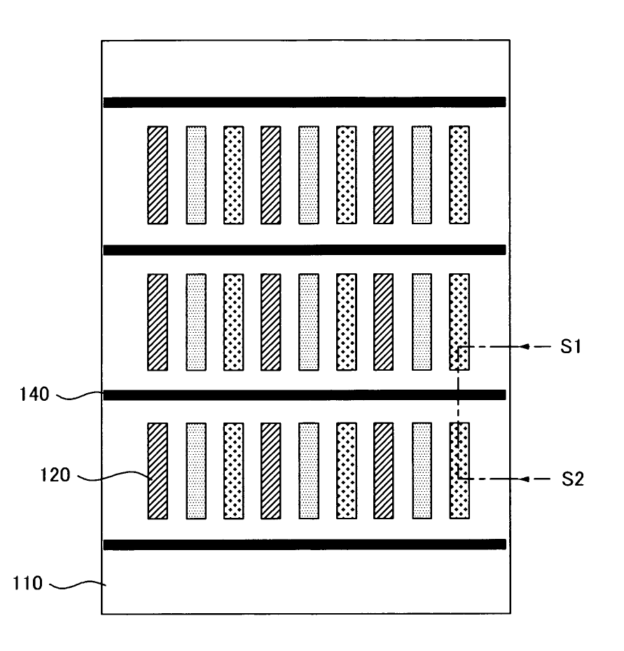

FIGS. 1A to 1C illustrate various implementations of a color image display method in an organic light emitting device. Other implementations may also be used. FIG. 1A illustrates a color image display method in an organic light emitting device that separately includes a red organic light emitting layer 15R to emit red light, a green organic light emitting layer 15G to emit green light and a blue organic light emitting layer 15B to emit blue light. The red, green and blue light produced by the red, green and blue organic light emitting layers 15R, 15G and 15B may be mixed to display a color image.

In FIG. 1A, the red, green and blue organic light emitting layers 15R, 15G and 15B may each include an electron transport layer, an emitting layer, a hole transport layer, and the like. FIG. 1A also shows a substrate 10, an anode electrode 12 and a cathode electrode 18. Different dispositions and configurations of the substrate 10, the anode electrode 12 and the cathode electrode 18 may also be used.

FIG. 1B illustrates a color image display method in an organic light emitting device that includes a white organic light emitting layer 25W to emit white light, a red color filter 20R, a green color filter 20G and a blue color filter 20B. And the organic light emitting device further may include a white color filter (not shown).

As shown in FIG. 1B, the red color filter 20R, the green color filter 20G and the blue color filter 20B each receive white light produced by the white organic light emitting layer 25W and produce red light, green light and blue light, respectively. The red, green and blue light may be mixed to display a color image. In FIG. 1B, the white organic light emitting layer 25W may include an electron transport layer, an emitting layer, a hole transport layer, and the like.

FIG. 1C illustrates a color image display method in an organic light emitting device that includes a blue organic light emitting layer 35B to emit blue light, a red color change medium 30R, a green color change medium 30G and a blue color change medium 30B.

As shown in FIG. 1C, the red color change medium 30R, the green color change medium 30G and the blue color change medium 30B each receive blue light produced by the blue organic light emitting layer 35B and produce red light, green light and blue light, respectively. The red, green and blue light may be mixed to display a color image. In FIG. 1C, the blue organic light emitting layer 35B may include an electron transport layer, an emitting layer, a hole transport layer, and the like.

FIG. 2 is a view illustrating an organic light emitting device in accordance with an example embodiment of the present invention. Other embodiments and configurations are also within the scope of the present invention.

As shown in FIG. 2, an organic light emitting device may include a plurality of subpixels 120 provided on a substrate 110. The substrate 110 may be formed of a material having good mechanical strength and dimensional stability.

The substrate 110 may include a glass plate, a metal plate, a ceramic plate and/or a plastic plate (polycarbonate resin, acrylic resin, polyvinylchloride, polyethylene terephthalate resin, polyimide resin, polyester resin, epoxy resin, silicon resin, fluorine resin).

When the organic light emitting device is a passive matrix type, the subpixels 120 may have an organic light emitting layer between an anode and a cathode disposed on the substrate 110.

On the other hand, when the organic light emitting device is an active matrix type, the subpixels 120 may include a transistor array, an anode, a cathode and an organic light emitting layer disposed on the substrate 110.

The transistor array may include a driving transistor. A source or drain electrode of the driving transistor may be connected to the anode and the cathode. The organic light emitting layer may be disposed between the anode and the cathode. The transistor array may include one or more transistors and capacitors.

The subpixels 120 may be defined as one unit pixel that includes red, green, and blue subpixels. FIG. 2 shows that one subpixel 120 includes only red color, green color and blue color. However, other light emitting colors such as a white color, a red-yellow and a yellow may also be used.

Each subpixel 120 may include an organic light emitting layer that includes one or more of a hole injection layer, a hole transport layer, an electron transport layer, and an electron injection layer. The organic light emitting layer may further include a buffer layer, a blocking layer and/or the like so that flow of holes or electrons between the anode and the cathode can be controlled.

The transistor may be a switching transistor for switching a scan signal and/or the transistor may be a driving transistor for driving a data signal.

Subpixels may be selected according to a data signal and a scan signal supplied from outside the organic light emitting device and the subpixels may be excited to represent a desired image.

Details may be described in more detail with reference to a cross-sectional structure of an organic light emitting device in which subpixels have an active matrix type.

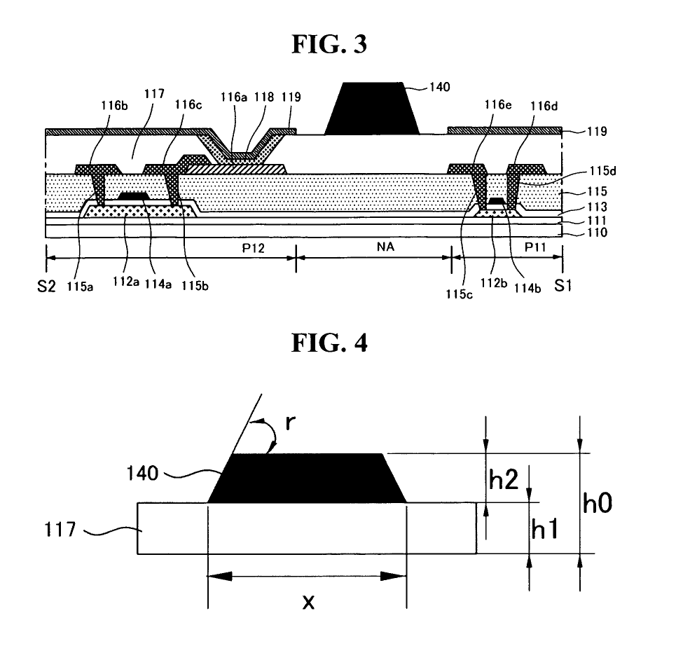

FIG. 3 is a cross-sectional view of an area S1-S2 ranging from a lower area of an eleventh subpixel P11 to an upper area of a twelfth subpixel P12a sub pixel of the organic light emitting device in accordance with an embodiment of this document.

As shown in FIG. 3, a switching transistor of the eleventh subpixel P11 is positioned in the area S1, and a driving transistor of twelfth subpixel P12 and an organic light emitting diode are positioned in the area S2. In other words, each subpixel includes at least one of a switching transistor and a driving transistor. A spacer 140 is positioned in an NA area between the area S1 and the area S2. Scan lines and source lines may be generally positioned in the NA area, however they are omitted in FIG. 2 for the convenience of explanation.

A section structure of the subpixel and a structure of the spacer 140 will be described below in the order of their manufacturing process without the separate division of the areas S1 and S2, with reference to the drawings.

A buffer layer 111 may be provided on the substrate 110. The buffer layer 111 may protect a thin film transistor, formed in a subsequent process, from impurities such as an alkali ion drained from the substrate 110. The buffer layer 111 may be formed from silicon oxide (SiO₂) or silicon nitride (SiNx), for example.

Semiconductor layers 112a and 112b may be formed on the buffer layer 111. The semiconductor layers 112a and 112b may include amorphous silicon, polycrystalline silicon or the like. Though not shown in FIG. 3, the semiconductor layers 112a and 112b may include a channel region, a source region and a drain region. The source region and the drain region may be doped with a P type impurity or an N type impurity.

A gate insulating film 113 may be provided over the substrate 110 and the semiconductor layers 112a and 112b. The gate insulating film 113 may be selectively formed from silicon oxide (SiO₂) or silicon nitride (SiNx), for example.

Gate electrodes 114a and 114b may be provided on the gate insulating film 113 in such a way to correspond to a channel region (i.e., a specific region of the semiconductor layer 112a and 112b). The gate electrodes 114a and 114b may include any one of aluminum (Al), aluminum alloy (Al alloy), titanium (Ti), silver (Ag), molybdenum (Mo), molybdenum alloy (Mo alloy), tungsten (W), and tungsten silicide (WSi₂), for example.

An interlayer insulating film 115 may be provided over the substrate 110 having the gate electrodes 114a and 114b. The interlayer insulating film 115 may be an organic film, an inorganic film or a combination thereof.

When the interlayer insulating film 115 is an inorganic film, the interlayer insulating film 115 may include silicon oxide (SiO₂), silicon nitride (SiNx) or silicate on glass (SOG).

On the other hand, when the interlayer insulating film 115 is an organic film, the interlayer insulating film 115 may include acrylic-based resin, polyimide-based resin or benzocyclobutene (BCB)-based resin, for example. First, second, third and fourth contact holes 115a, 115b, 115c and 115d may be disposed within the interlayer insulating film 115 and the gate insulating film 113. The first and second contact holes 115a and 115b may expose part of the semiconductor layer 112.

A first electrode 116a may be disposed on the interlayer insulating film 115. The first electrode 116a may be considered the anode and include a transparent conductive layer such as indium tin oxide (ITO) or indium zinc oxide (IZO), for example. The first electrode 116a may have a stacked structure of ITO/Ag/ITO.

Source electrodes 116b and 116d and drain electrodes 116bc and 116e may be disposed on the interlayer insulating film 115. The source electrodes 116b and the drain electrodes 116c in the area S2 may be included in the driving transistor of the twelfth subpixel P12, and the source electrodes 116d and the drain electrodes 116e in the area S1 may be included in the switching transistor of the eleventh subpixel P11.

The source electrodes 116b and 116d and the drain electrodes 116c and 116e may be electrically connected to the semiconductor layers 112a and 112b through the first, second, third and fourth contact holes 115a, 115b, 115c and 115d. In the case of the driving transistor, a part of the drain electrode 116c may be disposed on the first electrode 116a and electrically connected to the first electrode 116a .

The source electrodes 116b and 116d and the drain electrodes 116c and 116e may be formed from a low-resistance material in order to lower wiring resistance. The source electrodes 116b and 116d and the drain electrodes 116c and 116e may include a multi-layered film made of molybdenum (Mo), molytungsten (MoW), titanium (Ti), aluminum (Al) or aluminum alloy (Al alloy), for example. The multi-layered film may have a stacked structure of Ti/Al/Ti,Mo/Al/Mo or MoW/Al/MoW. However, the multi-layered film is not limited to the above example, as it may include other materials and/or structures.

The transistor disposed on the substrate 110 may include the gate electrodes 114a and 114b, the source electrodes 116b and 116d, and the drain electrodes 116 cb and 116e. The transistor array may further comprise circuit elements such as a capacitor as well as the above-described switching and driving transistors. The transistor array having a plurality of the transistors and the capacitors may be electrically connected to an organic light emitting device to be described below.

An insulating film 117 may include an organic material made of benzocyclobutene (BCB)-based resin, acrylic-based resin, polyimide-based resin or the like.

An organic light emitting layer 118 may be provided on the exposed first electrode 116a. A second electrode 119 (e.g. the cathode) may be provided on the organic light emitting layer 118. The second electrode 119 may be the cathode for supplying electrons to the organic light emitting layer 118. The second electrode 119 may include magnesium (Mg), silver (Ag), calcium (Ca), aluminum (Al) or an alloy thereof.

The organic light emitting device, connected to the source electrode 116b or the drain electrode 116c of the transistor array provided on the substrate 110, may include the first electrode 116a, the organic light emitting layer 118 and the second electrode 119.

The first electrode 116a provided on the source electrode 116b or the drain electrode 116c may be provided on a polishing film for polishing a surface of the transistor array.

The transistor array may have a different structure depending on a top gate or a bottom gate. Further, the transistor array may have a different structure depending on a number of masks and a semiconductor layer material used to form the transistor array. The structure of subpixels is not limited to the above description.

As shown in FIG. 2, spacers 140 may be disposed between the plurality of subpixels 120 provided on the substrate 110 in a matrix form. The spacers 140 may be provided in a bar fashion and in between rows of the subpixels 120 on the insulating film 117. For example, the spacers 140 may be disposed between subpixels arranged in a n^{th} row and subpixels arranged in a (n+1)^{th} row. However, the spacers 140 may not be provided between every row of the subpixels 120 shown in FIG. 2, but rather may be provided only in selected rows so that one or more rows are empty. Furthermore, the spacers 140 may be provided as sets together with spacers disposed in another row in a same shape or a same pattern.

The spacers 140 may be formed using a material different from the insulating film 117 or the same material as the insulating film 117. When the spacers 140 and the insulating film 117 are formed using a same material, the spacers 140 may extend from a bottom of the insulating film 117.

FIG. 4 is a cross-sectional view of a spacer and an insulating film of an organic light emitting device in accordance with an example embodiment of the present invention. Other embodiments and configurations are also within the scope of the present invention.

As shown in FIG. 4, the spacer 140 may have a positive taper shape in which a bottom area of the spacer 140 is wider than a top area of the spacer 140. The positive taper shape may extend in a direction away from the insulating film 117. As one example, the positive taper shape may be a trapezoidal shape. Other shapes of the spacer 140 may also be used.

The spacer 140 may cause a metal electrode layer (e.g. the cathode of the organic light emitting diode) formed on the spacer 140 to be provided within each subpixel with uniformity.

The spacer 140 may prevent or reduce scratches caused by contact of subpixels and a metal mask. As shown in FIG. 4, the spacers 140 may have a positive taper shape with a taper angle r of approximately 30-40 degrees. The taper angle r may be defined as an angle between a top or bottom surface of the spacer 140 and an inclined side of the spacer 140. The taper angle r may also be less than 30 degrees.

A height h2 of the spacer 140 may be greater than a height h1 of the insulating film 117. The height h2 may be a distance between a top surface and a bottom surface of the spacer 140. The height h1 of the insulating film 117 may be a distance between a top surface and a bottom surface of the spacer 140. Additionally, the height h1 of the insulating film 117 may be greater than the height of metal electrode layers (e.g. the source/drain electrodes of the transistor) provided below the insulating film 117. The height h2 of the spacer 140 and the height h1 of the insulating film 117 may also have a specific ratio.

The insulating film 117 may be patterned such that a bottom surface of the insulating film 117 is wide and a top surface of the insulating film 117 is narrow, such as in a same manner as the spacer 140 shown in FIG. 4. In this configuration, if the insulating film 117 is patterned to have a specific height, the spacer 140 may be formed on a non-emission region (i.e., a space on the top surface). If the height of insulating film 117 becomes greater than a specific height, then a region where the spacer 140 can be provided may be limited.

Examples of set heights of the insulating film 117 and the spacer 140 will be described below from a first viewpoint of the spacer 140 where height of the spacer 140 is controlled and height of the insulating film 117 is fixed and from a second viewpoint of the insulating film 117 where height of the insulating film 117 is controlled and height of the spacer 140 is fixed.

### [First Viewpoint of Spacer]

From a viewpoint of the spacer 140, the height h1 of the insulating film 117 and the height h2 of the spacer 140 may have a ratio of 1:2.6 to 4.0.

A case where resolutions of QVGA levels (320×240) will be described below as examples.

In one example, the height h1 of the insulating film 117 is 1.2 μm and the height h2 of the spacer 140 is 3.21 μm. Thus, a ratio of the height h1 of the insulating film 117 to the height h2 of the spacer 140 is 1:2.67.

As another example, the height h1 of the insulating film 117 is 1.2 μm and the height h2 of the spacer 140 is 3.5 μm. Thus, the ratio of the height h1 of the insulating film 117 to the height h2 of the spacer 140 is 1:2.91.

As still another example, the height h1 of the insulating film 117 is 1.2 μm and the height h2 of the spacer 140 is 3.8 μm. Thus, the ratio of the height h1 of the insulating film 117 to the height h2 of the spacer 140 is 1:3.16.

In another example, the height h1 of the insulating film 117 is 1.2 μm and the height h2 of the spacer 140 is 4.8 μm. Thus, the ratio of the height h1 of the insulating film 117 to the height h2 of the spacer 140 is 1:4.

The height h2 of the spacer 140 may be within a range of 2.0 μm to 5.0 μm. Further, the sum of the height h1 of the insulating film 117 and the height h2 of the spacer 140 may be within a range from 3 μm to 6 μm.

The height h2 of the spacer 140 may be 2.6 times greater than the height h1 of the insulating film 117 in order to prevent (or minimize) a failure rate of a device by preventing (or minimizing) occurrence of an alien substance due to contact of a metal mask (upon deposition) and an organic light emitting layer and/or a scratch caused by collision.
The height h2 of the spacer 140 may be 4.0 times greater than the height h1 of the insulating film 117 in order to prevent (or minimize) a shadow phenomenon due to the spacer 140 at time of a deposition. Further, since the height h1 of the insulating film 117 and the height h2 of the spacer 140 can be formed properly, electrical characteristics and uniformity of a material (e.g. aluminum (Al)) of a metal electrode layer (e.g. the cathode of the organic light emitting diode) formed on the spacer 140 can be improved.

In summary, the height h2 of the spacer 140 may be approximately 2.6 to 4.0 times greater than a height of the insulating film 117.

### [Second Viewpoint of Insulating Film]

From a viewpoint of the insulating film, the height h1 of the insulating film 117 and the height h2 of the spacer 140 may have a ratio of 1:0.37 to 0.9.

A case where resolutions are of QVGA levels (320×240) will be described below as examples.

In one example, the height h1 of the insulating film 117 is 1.8 μm and the height h2 of the spacer 140 is 3.21 μm. Thus, the ratio of the height h1 of the insulating film 117 to the height h2 of the spacer 140 is 1:0.56.

As another example, the height h1 of the insulating film 117 is 1.5 μm and the height h2 of the spacer 140 is 3.21 μm. Thus, the ratio of the height h2 of the spacer 140 to the height h1 of the insulating film 117 is 1:0.46.

As still another example, the height h1 of the insulating film 117 is 1.2 μm and the height h2 of the spacer 140 is 3.21 μm. Thus, the ratio of the height h2 of the spacer 140 to the height h1 of the insulating film 117 is 1:0.37.

From the above viewpoint, the height h1 of the insulating film 117 may be within a range of 0.5 μm to 3 μm. Further, the sum of the height h1 of the insulating film 117 and the height h2 of the spacer 140 may be within a range from approximately 3 μm to 6 μm.

The height h1 of the insulating film 117 may be 0.37 times greater than the height h2 of the spacer 140 such that an exposure process of the insulating film 117 can be facilitated and a minimum height where the organic light emitting layer can be formed may be set within an aperture of the insulating film 117. Further, when the insulating film 117 has the above-described height, the insulating film 117 may be uniformly formed to cover all the source and drain electrodes of the transistor provided below the insulating film 117. Leakage current between other metal electrodes or wirings with the insulating film 117 intervened therebetween may also be prevented and/or minimized.

The height h1 of the insulating film 117 may be 0.9 times smaller than the height h2 of the spacer 140 such that an exposure process of the insulating film 117 can be facilitated and occurrence of parasitic capacitance can be prevented and/or minimized. Electrical characteristics and uniformity of a material (e.g. aluminum (Al)) of a metal electrode layer (e.g. the cathode of the organic light emitting diode) formed on the insulating film 117 may also be improved.

The ratio of the height h2 of the spacer 140 to the height of the insulating film 117 may be as described above; however, the ratio is not limited to the above examples. The ratio may also be decided based on a width x of the spacer 140, resolutions (i.e., area of a subpixel) and/or other material properties.

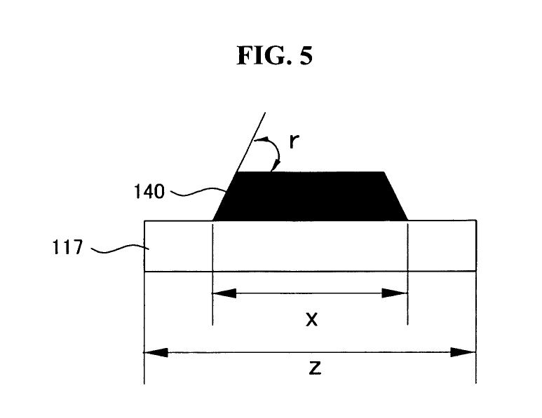

FIG. 5 is a cross-sectional view of a spacer and an insulating film of an organic light emitting device in accordance with an example embodiment of the present invention. Other embodiments and configurations are also within the scope of the present invention.

As shown in FIG. 5, the spacer 140 may have a positive taper shape in which a bottom surface of the spacer 140 is wider than a top surface of the spacer 140. The spacer 140 may cause a metal electrode layer (e.g. the cathode of the organic light emitting diode) formed on the spacer 140 to be provided within each subpixel with uniformity.

The spacer 140 may also prevent scratches caused by contact of subpixels and a metal mask. The spacer 140 may have a positive taper shape and have a taper angle r of 30-40 degrees or less, for example.

An overall shape of the spacer 140 may be decided based on the insulating film 117 provided below the spacer 140 so that a width x of the spacer 140 may be formed based on a comparison with a width z of the insulating film 117.

The width z of the insulating film 117 may be defined based on a top surface of the insulating film 117 (closest to the spacer 140) since the spacer 140 may be formed on the top surface of the insulating film 117. The width x of the spacer 140 may be defined based on a bottom surface of the spacer 140 (closest to the insulating layer 117) since the spacer 140 has the positive taper shape in which the bottom surface is wider than the top surface.

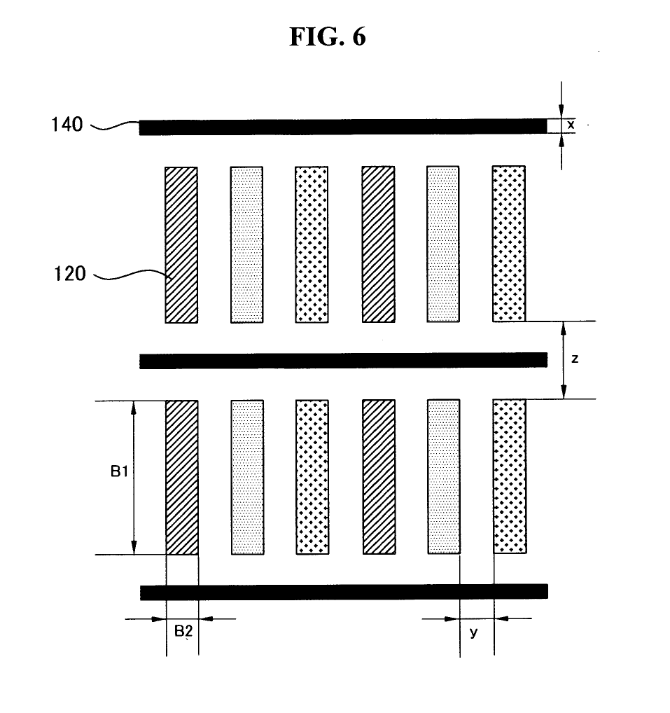

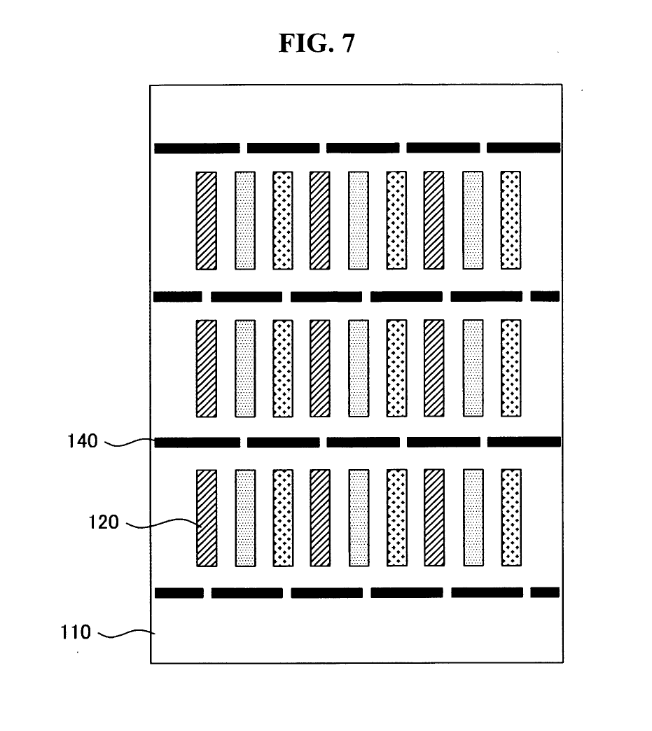

FIG. 6 is a view illustrating width of an insulating film and width of a spacer of an organic light emitting device in accordance with an example embodiment of the present invention. Other embodiments and configurations are also within the scope of the present invention.

As shown in FIG. 6, the substrate 110 may include a plurality of subpixel regions B1 and B2 and insulating film coating regions y and z at areas other than the subpixels 120. The plurality of spacers 140 may form at least one bar shape across a row region between the subpixels 120.

In the insulating film coating regions y and z, the region “y” becomes a factor to set a column region between the subpixels 120. The region “z” becomes a factor to set a row region between the subpixels 120. Regions “y” and “z” may be factors to set size and resolutions of the subpixels 120.

The region “z” may be a region where the spacer 140 can be located. The region “z” may be one factor for setting the width x of the spacer 140. In other words, the width x of the spacer 140 may depend on the width z of the row region between the subpixels 120 of the insulating film coating regions.

The ratio of the width x of the spacer 140 to the width 2 of the row region between the subpixels 120 of the insulating film coating region may be within a range of 1:1.1 to 2.8.

However, the width z of the row region between the subpixels 120 of the insulating film coating regions y and z and the width x of the spacer 140 may depend on an emission method of the organic light emitting device. Thus, the width z of the row region between the subpixels 120 and the width x of the spacer 140 may be described using a bottom emission method as one example and a top emission method as another example.

### [Bottom Emission Method]

A case where resolutions are QVGA levels (320×240) will be described below as examples.

As an example, the width z of the row region between the subpixels 120 of the insulating film coating regions y and z is 25 μm and the width x of the spacer 140 is 15 μm. Thus, the ratio of the width z of the row region between the subpixels 120 of the insulating film coating regions y and z to the width x of the spacer 140 is 1.6:1.

As another example, the width z of the row region between the subpixels 120 of the insulating film coating regions y and z is 25 μm and the width x of the spacer 140 is 25 μm. Thus, the ratio of the width z of the row region between the subpixels 120 of the insulating film coating regions y and z to the width x of the spacer 140 is 1.8:1.

As still another example, the width z of the row region between the subpixels 120 of the insulating film coating regions y and z is 54.5 μm and the width x of the spacer 140 is 20 μm. Thus, the ratio of the width z of the row region between the subpixels 120 of the insulating film coating regions y and z to the width x of the spacer 140 is 2.72:1.

### [Top Emission Method]

A case where resolutions are QVGA levels (320×240) will be described below as examples.

As an example, the width z of the row region between the subpixels 120 of the insulating film coating regions y and z is 19 μm and the width x of the spacer 140 is 10 μm. Thus, the ratio of the width z of the row region between the subpixels 120 of the insulating film coating regions y and z to the width x of the spacer 140 is 1.9:1.

As another example, the width z of the row region between the subpixels 120 of the insulating film coating regions y and z is 15 μm and the width x of the spacer 140 is 8 μm. Thus, the ratio of the width z of the row region between the subpixels 120 of the insulating film coating regions y and z to the width x of the spacer 140 is 1.5:1.

As still another example, the width z of the row region between the subpixels 120 of the insulating film coating regions y and z is 8 μm to the width x of the spacer 140 is 7 μm. Thus, the ratio of the width z of the row region between the subpixels 120 of the insulating film coating regions y and z to the width x of the spacer 140 is 1.14:1.

The numeral values according to the two types of emission methods may differ depending on the emission method when the width z of the row region between the subpixels 120 of the insulating film coating regions y and z and the width x of the spacer 140 are set.

In a bottom emission method, light may emit in a direction toward the substrate at which the transistor array is located. Thus, a margin width may be set large when designing the insulating film 117 and the spacer 140. In other words, in the bottom emission method, the transistor array disposed on the substrate may have an effect on a size of the aperture. Accordingly, in the bottom emission method, the width z of the row region between the subpixels 120 of the insulating film coating regions y and z may be within a range of approximately 25 μm to 55 μm and the width x of the spacer 140 may be within a range of approximately 16 μm to 30 μm.

From the numerical relationships, the ratio of the width x of the spacer 140 to the width z of the row region between the subpixels 120 of the insulating film coating regions y and z according to the bottom emission method may be approximately 1:1.5 to 2.8.

From a viewpoint of the spacer 140, the width x of the spacer 140 may be approximately 0.36 to 0.67 times greater than the width z of the row region between the subpixels 120 of the insulating film coating regions y and z.

If the width x of the spacer 140 is 0.36 times greater than the width z of the row region between the subpixels 120 of the insulating film coating regions y and z, the spacer 140 may support a metal mask at a minimum width at a time of a deposition process. This may improve electrical characteristics and uniformity of a material (e.g. aluminum (Al)) of a metal electrode layer (e.g. the cathode of the organic light emitting diode) formed over the insulating film 117 and the spacer 140.

Further, if the width x of the spacer 140 is 0.67 times smaller than the width z of the row region between the subpixels 120 of the insulating film coating regions y and z, a shadow phenomenon due to the width x of the spacer 140 may be prevented and/or minimized at a time of a deposition process. Further, the spacer 140 may be formed to have a robust shape enough to support the metal mask and an encapsulation member after an encapsulation process.

In the top emission method, since light is emitted in an opposite direction to the substrate where the transistor array is placed, a margin width may be set small when designing the insulating film 117 and the spacer 140. In other words, in the top emission method, the transistor array provided on the substrate may not have an influence on size of the aperture. Accordingly, in the top emission method, the width z of the row region between the subpixels 120 of the insulating film coating regions y and z may be in a range of approximately 8 μm to 25 μm and the width x of the spacer 140 may be within a range of approximately 6 μm to 16 μm.

From the numerical relationships, the ratio of the width x of the spacer 140 to the width z of the row region between the subpixels 120 of the insulating film coating regions y and z according to the bottom emission method may be approximately 1:1.1 to 1.6.

From a viewpoint of the spacer 140, the width x of the spacer 140 may be approximately 0.62 to 0.90 times greater than the width z of the row region between the subpixels 120 of the insulating film coating regions y and z.

If the width x of the spacer 140 is 0.62 times greater than the width z of the row region between the subpixels 120 of the insulating film coating regions y and z, the spacer 140 may support a metal mask at a minimum width at a time of a deposition process. The spacer 140 may also improve electrical characteristics and uniformity of a material (e.g. aluminum (Al)) of a metal electrode layer (e.g. the cathode of the organic light emitting diode) formed over the insulating film 117 and the spacer 140. A phenomenon in which electric charges are concentrated on the metal electrode layer may be prevented and/or minimized, and a phenomenon in which stripes appear on the screen may be prevented and/or minimized.

In addition, when the width x of the spacer 140 is 0.90 times smaller than the width z of the row region between the subpixels 120 of the insulating film coating regions y and z, a shadow phenomenon due to the width x of the spacer 140 at the time of a deposition process may be prevented and/or minimized. The occurrence of alien substance within an aperture of the subpixel may also be prevented and/or minimized. Further, the spacer 140 may be formed to have a robust shape enough to support a metal mask and also an encapsulation member after an encapsulation process.

The above description relates to a ratio capable of securing an aspect ratio of the organic light emitting layer as numerical values by setting the width x of the spacer 140 with respect to the width z of the row region between the subpixels 120 of the insulating film coating regions y and z. If the insulating film 117 and the spacer 140 are formed as described above, the aspect ratio may be improved by approximately 20% or greater. The above-described ratio relationships may be established by considering one or more of the height of the spacer 140, resolutions (i.e., the area of a subpixel) and/or material properties.

The spacer 140 of FIG. 2 may have other shapes and/or arrangements as will be described with reference to FIGS. 7 to 9.

FIGS. 7 to 9 are schematic plan views of an organic light emitting device in accordance with example embodiments of the present invention. Other embodiments and configurations are also within the scope of the present invention.

As shown in FIG. 7, the spacers 140 may have a bar shape divided along one row region. The spacers 140 may have a structure in which the spacers 140 are divided in a same length or different lengths such that they are spaced apart from one another (such as at predetermined distances) along a same row (or same row region). The divided spacers 140 may have same lengths or different lengths. The spacers 140 on a same row region may be divided so that the spacers are spaced apart from one another along the same row region.

In the divided spacers 140, a region of a first spacer located in an n^{th} row region and a region of a second spacer located in a (n+1)^{th} row region may be provided such that they partially overlap with each other.

In other words, the divided spacers 140 may be disposed in zigzags on the substrate 110. Divided spacers 140 may prevent a metal mask from sinking in a specific region.

This structure may increase step coverage when forming a metal electrode layer within the subpixels 120 and may also improve uniformity of electrodes. Further, since the spacers 140 may be provided in zigzags on the substrate 110, the metal mask may be prevented from sinking in a specific region.

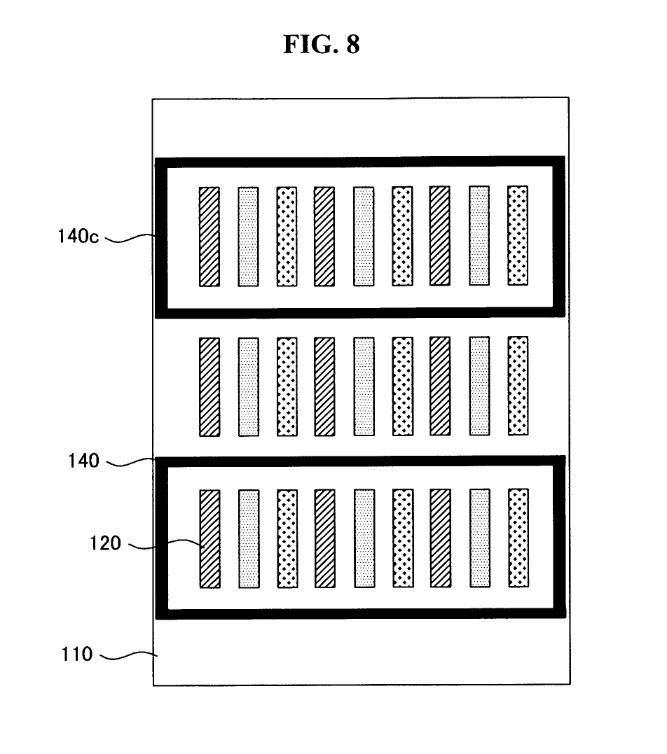

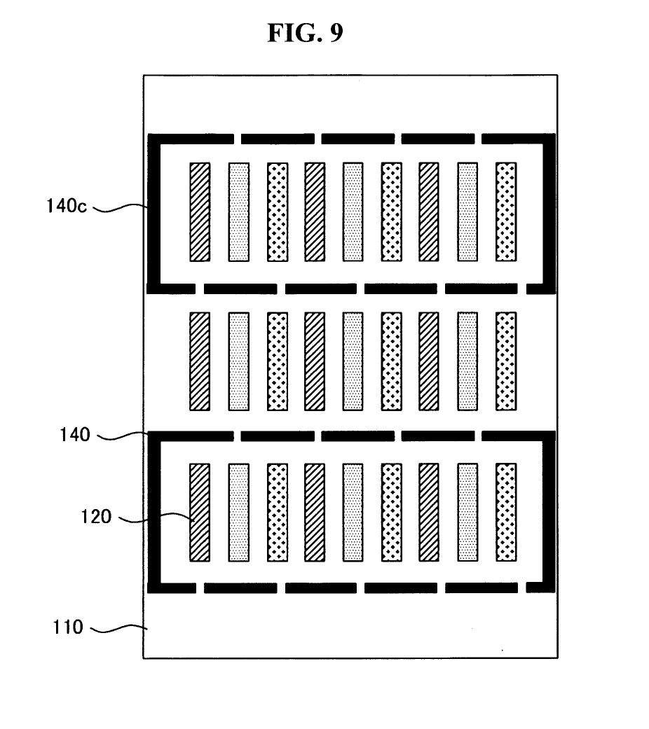

As shown in FIG. 8, the spacers 140 may have a bar shape (as in FIG. 2), but also include a structure in which the spacers 140 are interconnected by connection units 140c to connect distal ends of the spacers 140. This structure may prevent stress caused by external pressure and may also introduce moisture by open air. Further, in the event that an encapsulation substrate is glass, the structure may support the encapsulation substrate in all aspects of the substrate 110.

As shown in FIG. 9, the connection units 140c may be formed in the spacers 140 (as in FIG. 7) in order to interconnect distal ends of the spacers 140.

The spacers 140 may also be formed from a black-series material in order to shield or absorb externally incident light. That is, the spacers 140 may function similarly as a black matrix.

Embodiments of the present invention may provide an organic light emitting device that can improve production yield and reliability.

The above description relates to a plurality of subpixels 120 on a substrate. For example, FIGS. 1A-1C show different arrangements of red, blue, green and white light emitting layers to produce various combinations of red, blue and green light. Other combinations and/or colors may be used. The light emitting layers of the subpixels may include phosphorescence material and/or fluorescence material. The arrangements of FIGS. 1A-1C may be provided within any of the embodiments of the present invention and/or displays associated with each of FIGS. 2-9.

In an example where the subpixel emits red light, the emitting layer of the subpixel may include a host material including carbazole biphenyl (CBP) or 1,3-bis(carbazol-9-yl (mCP), and may be formed of a phosphorescence material including a dopant material including PIQIr(acac)(bis(1-phenylisoquinoline)acetylacetonate iridium), PQIr(acac)(bis(1-phenylquinoline)acetylacetonate iridium), PQIr(tris(1-phenylquinoline)iridium), or PtOEP(octaethylporphyrin platinum) or a fluorescence material including PBD:Eu(DBM)3(Phen) or Perylene.

In an example where the subpixel emits green light, the emitting layer may include a host material including CBP or mCP, and may be formed of a phosphorescence material including a dopant material including Ir(ppy)3(fac tris(2-phenylpyridine)iridium) or a fluorescence material including Alq3(tris(8-hydroxyquinolino)aluminum).

In an example where the subpixel emits blue light, the emitting layer may includes a host material including CBP or mCP, and may be formed of a phosphorescence material including a dopant material including (4,6-F2ppy)2Irpic or a fluorescence material including spiro-DPVBi, spiro-6P, distyryl-benzene (DSB), distyryl-arylene (DSA), PFO-based polymers, PPV-based polymers, or a combination thereof.

An example embodiment of the present invention may provide an organic light emitting device that may improve production yield and reliability.

An example embodiment of the present invention may provide an organic light emitting device that includes a substrate having a plurality of subpixels provided thereon, an insulating film disposed on the substrate and configured to divide the plurality of subpixels, and a plurality of spacers disposed on the insulating film each having a positive taper shape. A height of each spacer may be approximately 2.6 to 4.0 greater than a height of the insulating film.

An example embodiment of the present invention may provide an organic light emitting device that includes a substrate having a plurality of subpixels provided thereon, an insulating film disposed on the substrate and configured to divide row regions between the plurality of subpixels, and a plurality of spacers disposed on the insulating film each having a positive taper shape. A height of the insulating film may be approximately 0.39 to 0.9 greater than a height of each spacer. A width of each spacer may be approximately 0.3 to 0.9 greater than a width of the insulating film.

An example embodiment of the present invention may provide an organic light emitting device that includes a substrate having a plurality of subpixels provided thereon, an insulating film disposed on the substrate and configured to divide row regions between the plurality of subpixels, and a plurality of spacers disposed on the insulating film each having a positive taper shape. A width of each spacer may be approximately 0.3 to 0.9 greater than a width of the insulating film.

A difference between driving voltages, e.g., the power voltages VDD and Vss of the organic light emitting device may change depending on the size of the display panel 100 and a driving manner. A magnitude of the driving voltage is shown in the following Tables 1 and 2. Table 1 indicates a driving voltage magnitude in case of a digital driving manner, and Table 2 indicates a driving voltage magnitude in case of an analog driving manner.

TABLE 1

| Size (S) of display | VDD- | | |
|---|---|---|---|
| panel | Vss (R) | VDD-Vss (G) | VDD-Vss (B) |
| S < 3 inches | 3.5-10 (V) | 3.5-10 (V) | 3.5-12 (V) |
| 3 inches < S < 20 inches | 5-15 (V) | 5-15 (V) | 5-20 (V) |
| 20 inches < S | 5-20 (V) | 5-20 (V) | 5-25 (V) |

TABLE 2

| Size (S) of display panel | VDD-Vss (R, G, B) |
|---|---|
| S < 3 inches | 4~20 (V) |
| 3 inches < S < 20 inches | 5~25 (V) |
| 20 inches < S | 5~30 (V) |

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An organic light emitting device comprising:
a substrate having a plurality of subpixels provided thereon;
an insulating film on the substrate to separate the plurality of subpixels; and
a plurality of spacers on the insulating film each having a positive taper shape in a direction,
wherein a height of one spacer in the direction is approximately 2.6 to 4.0 greater than a height of the insulating film in the direction.

2. The organic light emitting device of claim 1, wherein the height of the insulating film is greater than a height of an electrode layer adjacent to the insulating film.

3. The organic light emitting device of claim 1, wherein the spacers are formed of different materials than the insulating film.

4. The organic light emitting device of claim 1, wherein a sum of the height of the one spacer and the height of the insulating film is within a range of approximately 3 μm to 6 μm.

5. The organic light emitting device of claim 1, wherein the height of the one spacer is within a range of approximately 2 μm to 5 μm.

6. The organic light emitting device of claim 1, wherein the plurality of spacers form at least one bar shape across a row region between the subpixels, or the spacers on a same row region are divided so that the spacers are spaced apart from one another along the same row region.

7. The organic light emitting device of claim 1, wherein the spacers are provided along every row region between the subpixels, or the spacers are provided along at least one row region with one or more row regions being without the spacers.

8. The organic light emitting device of claim 1, wherein a width of the spacer in another direction is approximately 0.3 to 0.9 times greater than a width of the insulating film in the another direction.

9. The organic light emitting device of claim 1, wherein at least one of the plurality of subpixels includes a phosphorescent material.

10. An organic light emitting device comprising:
a substrate having a plurality of subpixels provided thereon;
an insulating film on the substrate to separate the plurality of subpixels; and
a plurality of spacers on the insulating film each having a positive shape extending in a direction,
wherein a width of one of the spacers in another direction is approximately 0.3 to 0.9 of a width of the insulating film in the another direction, and wherein a height of the one spacer in the direction is approximately 2.6 to 4.0 greater than a height of the insulating film in the direction.

12. The organic light emitting device of claim 10, wherein a sum of the height of the one spacer and the height of the insulating film is within a range of approximately 3 μm to 6 μm.

13. The organic light emitting device of claim 10, wherein the height of the insulating film is within a range of approximately 0.5 μm to 3 μm.

14. The organic light emitting device of claim 10, wherein the height of the one spacer is within a range of approximately 2 μm to 5 μm.

15. The organic light emitting device of claim 10, wherein the width of the insulating film is within a range of approximately 25 μm to 55 μm when light of each subpixel is emitted in a direction of the substrate.

16. The organic light emitting device of claim 15, wherein the width of the one spacer is within a range of approximately 16 μm to 30 μm.

17. The organic light emitting device of claim 10, wherein the width of the insulating film is within a range of 8 μm to 25 μm when light of each subpixel is emitted in a direction away from the substrate.

18. The organic light emitting device of claim 17, wherein the width of the one spacer is within a range of 6 μm to 16 μm.

19. An organic light emitting device comprising:
a substrate;
an insulating film on the substrate to separate subpixels; and
at least one spacer on the insulating film having a positive shape,
wherein a width of the at least one spacer along a direction is approximately 0.3 to 0.9 of a width of the insulating film along the same direction.

20. The organic light emitting device of claim 19, wherein the width of the insulating film is approximately 25 μm to 55 μm when light of each subpixel is emitted in a direction toward the substrate.

21. The organic light emitting device of claim 20, wherein the width of the at least one spacer is approximately 16 μm to 30 μm.

22. The organic light emitting device of claim 19, wherein the width of the insulating film is approximately 8 μm to 25 μm when light of each subpixel is emitted in a direction away from the substrate.

23. The organic light emitting device of claim 22, wherein the width of the at least one spacer is approximately 6 μm to 16 μm.

24. The organic light emitting device of claim 19, wherein a height of the insulating film in another direction is greater than a height of an electrode layer adjacent to the insulating film.

25. The organic light emitting device of claim 19, wherein a height of the at least one spacer in another direction is approximately 2.6 to 4.0 greater than a height of the insulating film in the another direction.
